(19) United States
(12) Patent Application Publication
(10) Pub. No.: US 2014/0210690 A1
(43) Pub. Date: Jul. 31, 2014

(54) REAL-TIME MULTITASK OPERATING METHOD AND ELECTRONIC DEVICE

(71) Applicant: E Ink Holdings Inc., Hsinchu (TW)

(72) Inventors: Cheng-Hao Lee, Hsinchu (TW); Chun-Wei Chu, Hsinchu (TW)

(73) Assignee: E Ink Holdings Inc., Hsinchu (TW)

(21) Appl. No.: 14/061,713

(22) Filed: Oct. 23, 2013

(30) Foreign Application Priority Data
Jan. 28, 2013 (TW) 102103179

(51) Int. Cl. G06F 3/14

(52) U.S. Cl. CPC G06F 3/1423
USPC 345/1.3

(57) ABSTRACT

A real-time multitask operating method for an electronic device. The electronic device has a first display device and a second display device. The first display device and the second display device are respectively disposed on two surfaces of the electronic device corresponding to each other. In the method, a signal is received when a first function is executed by the electronic device to display a first frame corresponding to the first function by the first display device. The first frame and a second frame corresponding to the signal are displayed on the first display device and the second display device according to the signal when the first function is still executed. The first frame and the second frame are displayed on different display devices.

### CROSS-REFERENCE TO RELATED APPLICATION

This application claims the priority benefit of Taiwan application serial no. 102103179, filed on Jan. 28, 2013. The entirety of the above-mentioned patent application is hereby incorporated by reference herein and made a part of this specification.

### BACKGROUND OF THE INVENTION

1. Field of the Invention

The invention relates to an operating method and an electronic device, and more particularly relates to a real-time multitask operating method and an electronic device using the same.

2. Description of Related Art

With continuous improvement of mobile devices (such as smart phones or tablet computers) in confidentiality and convenience, a mobile device has become an electronic product indispensable to people nowadays. In addition to sharing information anytime or chatting on line via the mobile device, a user can install diverse applications on the mobile device, so as to execute various convenient features provided by the applications. However, one possible reason to most of mobile devices circulated in the market which failed to support multitask operations is that a working performance of a processor being insufficient, whereas another possible reason thereto is that a size of a display on the mobile device is incapable of displaying frames corresponding to various functions onto the same display during multitask operation. Therefore, current design in mobile devices utilizes at least one function bottom (e.g., a physical bottom or a virtual bottom) to switch between different frames corresponding to different functions onto one single display device. This may result in operational complexity which requires the user to constantly pressing the function bottom to browse between frames corresponding to the functions.

Moreover, current design in mobile devices only provides one signal display device for the user to browse the frames and operate interactively. Therefore, when an incoming call signal is received by the electronic device, the frame and operating function being executed is interrupted immediately to display an incoming call signal interface. As a result, an entertaining effect of the device is reduced since the user may not be able to sustain current activities (such as playing a game application).

### SUMMARY OF THE INVENTION

The invention is directed to a real-time multitask operating method and an electronic device using the same, which may display frames corresponding to various functions being executed at the same time by different display devices, so as to realize a real-time multitask operation for the electronic device.

The invention provides a real-time multitask operating method for an electronic device having a first display device and a second display device. The first display device and the second display device are respectively disposed on two surfaces of the electronic device corresponding to each other. The method includes: displaying the first frame and the second frame corresponding to the signal by the first display device and the second display device, and displaying the first frame and a second frame corresponding to the signal by the first display device and the second display device according to the signal when the first function is still executed by the electronic device, and the first frame and the second frame are displayed on different display devices.

According to the real-time multitask operating method in an embodiment of the invention, the step of displaying the first frame and the second frame corresponding to the signal by the first display device and the second display device includes: displaying the first frame by the second display device when the first function is still executed by the electronic device, and displaying the second frame by the first display device.

According to the real-time multitask operating method in an embodiment of the invention, a premise of the steps of displaying the first frame by the second display device and displaying the second frame by the first display device is that the signal matches a display priority of the first display device.

According to the real-time multitask operating method in an embodiment of the invention, the step of displaying the first frame and the second frame corresponding to the signal by the first display device and the second display device includes: displaying the second frame corresponding to the signal by the second display device according to the signal when the first function is still executed by the electronic device to display the first frame by the first display device.

According to the real-time multitask operating method in an embodiment of the invention, the second display device includes an electronic paper display device.

According to the real-time multitask operating method in an embodiment of the invention, the first display device includes an electronic paper display device.

According to the real-time multitask operating method in an embodiment of the invention, the signal includes a short message, an event notification message, a call signal, a video stream signal or a function-activating signal.

A display device according to an embodiment of the invention includes a first display device, a second display device and a processor. The first display device and the second display device are respectively disposed on two surfaces of the electronic device corresponding to each other. The processor is coupled to the first display device and the second display device. The processor is configured for: receiving a signal when a first function is executed to display a first frame corresponding to the first function by the first display device, and displaying the first frame and a second frame corresponding to the signal by the first display device and the second display device according to the signal when the first function is still executed. The first frame and the second frame are displayed on different display devices.

According to the electronic device in an embodiment of the invention, the processor displaying the first frame and the second frame corresponding to the signal by the first display device and the second display device further includes: displaying the first frame by the second display device when the first function is still executed by the electronic device, and displaying the second frame by the first display device.

According to the electronic device in an embodiment of the invention, a premise of displaying the first frame by the second display device and displaying the second frame by the first display device is that the signal matches a display priority of the first display device.

According to the electronic device in an embodiment of the invention, the processor displaying the first frame and the second frame corresponding to the signal by the first display device and the second display device further includes: displaying the second frame corresponding to the signal by the second display device according to the signal when the first function is still executed by the electronic device to display the first frame by the first display device.

According to the electronic device in an embodiment of the invention, the second display device includes an electronic paper display device.

According to the electronic device in an embodiment of the invention, the first display device includes an electronic paper display device.

According to the electronic device in an embodiment of the invention, the signal includes a short message, an event notification message, a call signal, a video stream signal or a function-activating signal.

According to the electronic device in an embodiment of the invention, the electronic device further includes a detachable case covering a second surface of the electronic device corresponding to a first surface disposed with the first display device, and the second display device is disposed on the detachable case.

According to the electronic device in an embodiment of the invention, the second display device receives a display signal from the processor by using a wired method or a wireless method.

Accordingly, the configuration of dual display devices of the electronic device and the real-time multitask operating method according to the invention may allow the user to freely customize specific common functions or select a system default setting as to switch all display contents on the first display device to be displayed on the second display device, so that the user may perform more than two functions at the same time, such as making a phone call while checking on Emails. Moreover, when the signal is received, the electronic device of the invention may also display the frame corresponding to the signal on one display device when the user is still using a specific function on another display device. This allows the user to concentrate in using the electronic device (such as playing game or watching video) without being interrupted by the phone call. Instead, the frame corresponding to the signal received (which is deemed as an interruption to the user) can be displayed on another display device, so that the user may turn the electronic device over and decide whether to answer the phone call.

To make the above features and advantages of the invention more comprehensible, several embodiments accompanied with drawings are described in detail as follows.

### BRIEF DESCRIPTION OF THE DRAWINGS

FIG. 1 is a schematic view of an electronic device according to an embodiment of the invention.

FIG. 1A is a schematic view of an electronic device and a detachable case according to an embodiment of the invention.

FIG. 2 is a flowchart of a real-time multitask operating method according to an embodiment of the invention.

FIG. 3 illustrates two display devices of an electronic device according to an embodiment of the invention which respectively display frames corresponding to different functions being executed.

FIG. 4 is a flowchart of different frames respectively displayed on two display devices according to an embodiment of the invention.

FIG. 5 is a flowchart of different frames respectively displayed on two display devices according to another embodiment of the invention.

### DESCRIPTION OF THE EMBODIMENTS

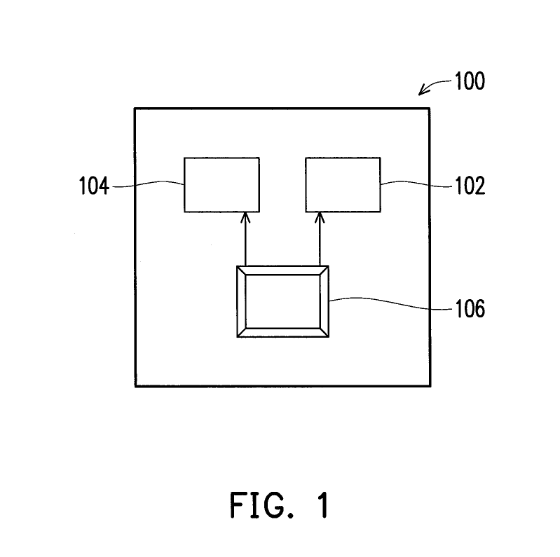

FIG. 1 is a schematic view of an electronic device according to an embodiment of the invention. Referring to FIG. 1, a display device 100 of the present embodiment includes a first display device 102, a second display device 104 and a processor 106. Among which, the electronic device 100 can be, for example, a cell phone, a smart phone, an electronic book, a game machine or a tablet PC, the invention is not limited thereto. The first display device 102 can be, for example, an electronic paper display device, an organic light-emitting diode (OLED) display, a bistable display or a light-emitting diode (LED) display. The second display device 104 can be, for example, an electronic paper display device, an organic light-emitting diode (OLED) display, a bistable display or a light-emitting diode (LED) display. The processor 106 can be, for example, a micro-processor, an embedded controller or a central processing unit (CPU).

In addition, the electronic device 100 includes two surfaces corresponding to each other (e.g., a first surface 100a and a second surface 100b as illustrated in FIG. 1A), and the first display device 102 and the second 104 are respectively disposed on the two surfaces of the electronic device corresponding to the each other. In addition, the processor 106 is coupled to the first display device 102 and the second display device 104, respectively.

In the present embodiment, the first display device 102 and the second display device 104 can be respectively assembled on two surfaces of the electronic device 100 corresponding to each other. However, the invention is not limited thereto. That is, the second display device 104 can also be mounted (adhered) on a detachable case of the electronic device 100. FIG. 1A is a schematic view of an electronic device and a detachable case according to an embodiment of the invention. Referring to FIG. 1A, in another embodiment, the electronic device 100 can further include a detachable case (e.g., a protective case of a cell phone) 110. The detachable case 110 covers the second surface 100b of the electronic device 100 corresponding to the first surface 100a disposed with the first display device 102, and the second display device 104 is disposed (adhered) on the detachable case 110. Further, in the electronic device, the second display device 104 assembled on the second surface 100b or the second display device 104 mounted (adhered) on the detachable case 110 can receive a display signal from the processor 106 by using a wired method or a wireless method, so as to display the frames.

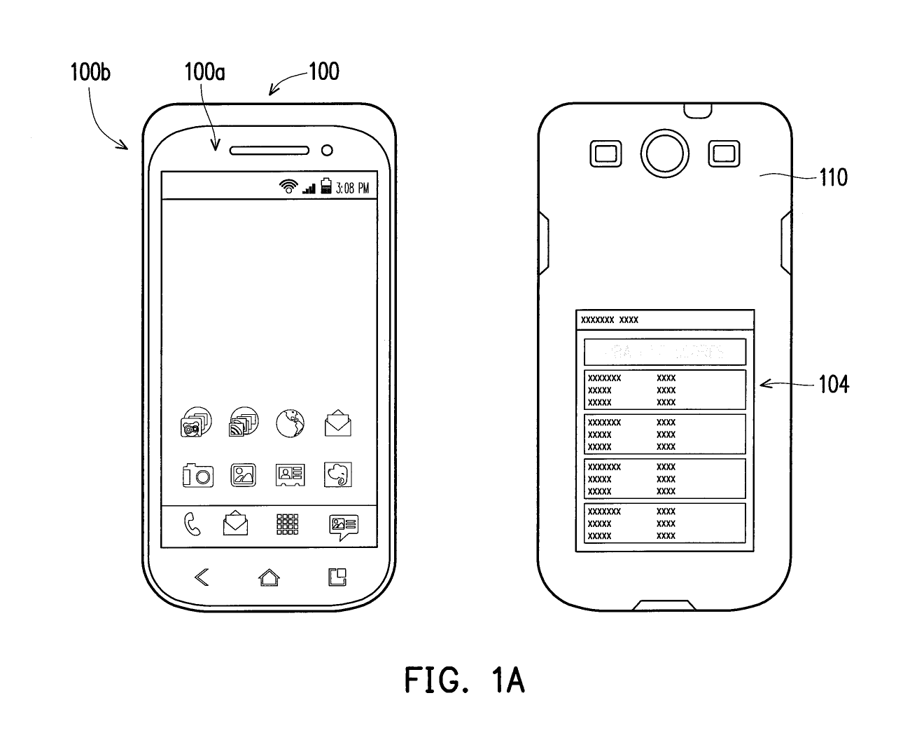

FIG. 2 is a flowchart of a real-time multitask operating method according to an embodiment of the invention. Referring to FIG. 1 and FIG. 2 together, in step S201, a signal is received when a first function is executed by the processor 106 of the electronic device 100 to display a first frame corresponding to the first function on the first display device 102. The first function can be, for example, executing an application (including functional operations of the electronic device such as video playing, multimedia operation, browsing text, Internet surfing, etc.). The signal includes a short message, an event notification message, a call signal, a video stream signal or a function-activating signal. That is, the signal can be the short message, the call signal or the video streaming signal received through a communication interface of the electronic device, and also can be the event notification message automatically generated by the processor 106 or the function-activating signal generated based on the control signal received by the processor 106.

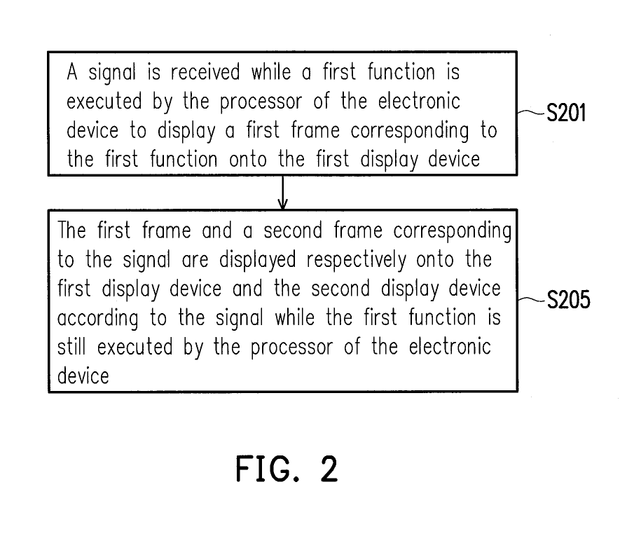

In step S205, the first frame and a second frame corresponding to the signal are displayed on the first display device 102 and the second display device 104 according to the signal when the first function is still executed by the processor 106 of the electronic device 100. It should be noted that, the first frame and the second frame are displayed respectively on different display devices. FIG. 3 illustrates two display devices of an electronic device according to an embodiment of the invention which respectively display frames corresponding to different functions being executed. Referring to FIG. 3, for instance, when a user executes a call function of the electronic device 100, a call interface (the first frame) for executing the call function is displayed on the first display device 102. Meanwhile, the event notification message (such as a weather forecast) is received by the electronic device 100 and a weather forecast frame (the second frame) corresponding to the even notification message is displayed on the second display device 104. In the present embodiment, when the first display device 102 is still maintained in a state of displaying the first frame corresponding to the function being executed, the second frame corresponding to the signal is displayed on the second display device 104. Nonetheless, the present invention is not limited thereto. That is, it falls within the scope of the present invention, as long as the first frame corresponding to the function being executed and the second frame corresponding to the signal are displayed respectively on different display devices after the signal is received by the processor 106.

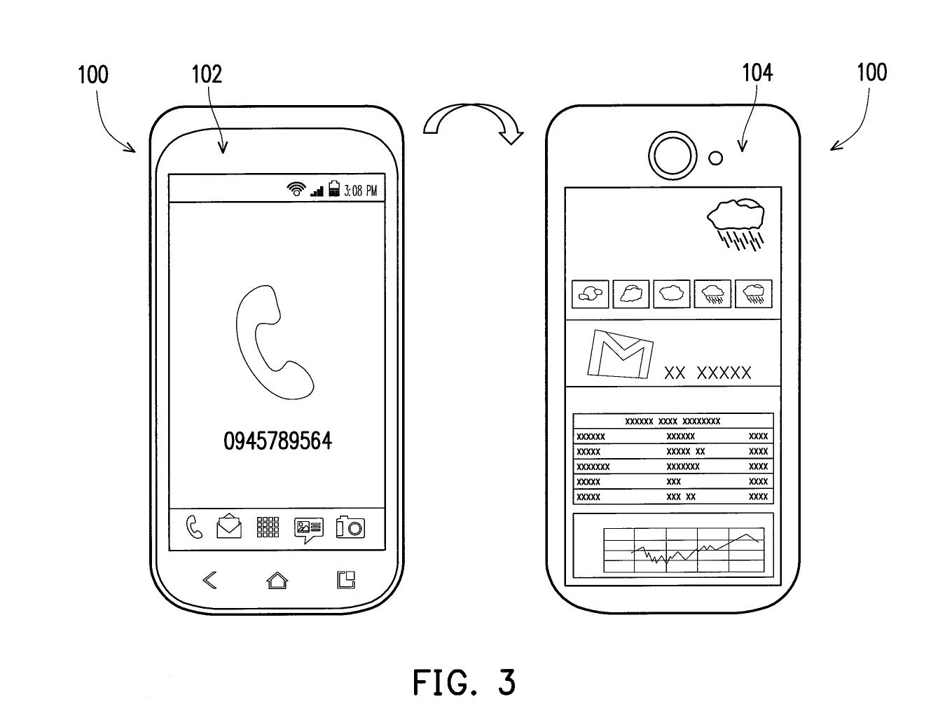

Embodiments with reference to the figures are provided and served to explain the step for displaying said two different frames respectively by different display devices as described above (i.e., step S205). FIG. 4 is a flowchart of different frames respectively displayed on two display devices according to an embodiment of the invention. Referring to FIG. 4, in the present embodiment, the step for the processor 106 to display the first frame and the second frame by the first display device 102 and the second display device 104 (step S205) further includes: in step S401, the processor 106 makes the first frame to be displayed on the second display device 104 when the first function is still executed by the processor 106 of the electronic device 100. Next in step S405, the second frame is displayed on the first display device 102. Namely, after the signal is received by the processor 106, the second frame corresponding to the signal is displayed on the first display device 102, and the first frame originally displayed on the first display device 102 is switched to be displayed on the second display device 104. According to another embodiment of the invention, after the signal is received by the processor 106 of the electronic device 100, whether the signal matches a display priority of the first display device 102 can then be determined first. In case when the signal received by the processor 106 matches the display priority of the first display device 102, the first frame is displayed on the second display device 104 and the second frame corresponding to the signal received is displayed on the first display device 102. It should be noted that, the user can customize the display priority of the first display device based on operating habits and preferences of the user.

For instance, the processor 106 displays a short message interface by the first display device 102 when the user browses the short message. At the same time, the processor 106 receives the signal which is the call signal, the display priority of the call interface corresponding to the signal is higher than that of the short message interface corresponding to the short message. In this case, the short message interface originally displayed on the first display device 102 is switched to be displayed on the second display device 104, whereas the call interface corresponding to the signal is displayed on the first display device 102.

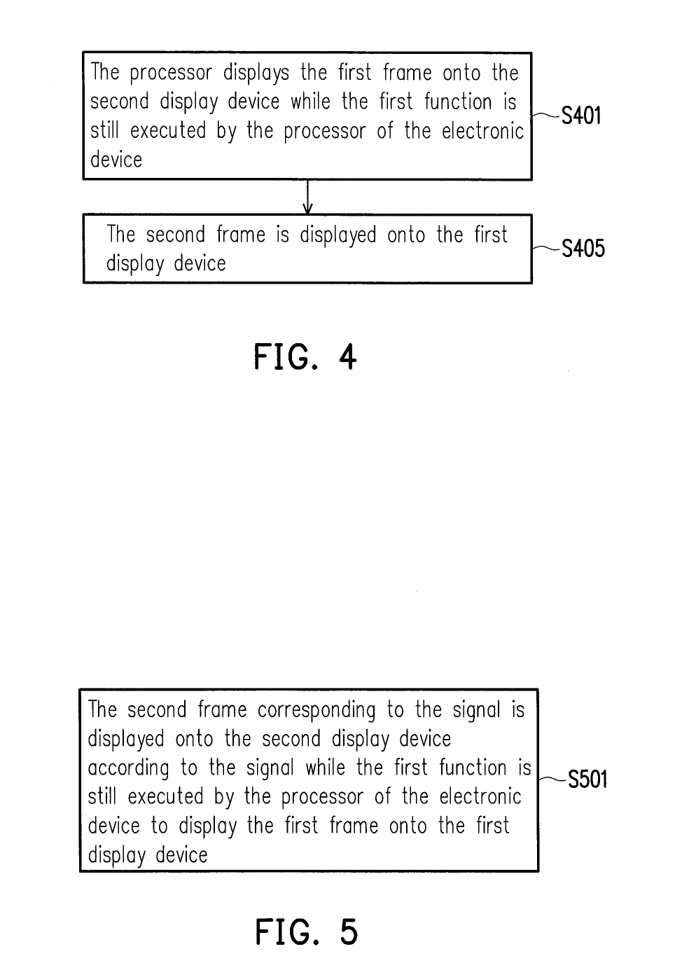

FIG. 5 is a flowchart of different frames respectively displayed on two display devices according to another embodiment of the invention. Referring to FIG. 5, in the present embodiment, the step for the processor 106 to display the first frame and the second frame by the first display device 102 and the second display device 104 (step S205) further includes: in step S501, the second frame corresponding to the signal is displayed on the second display device 104 according to the signal when the first function is still executed by the processor 106 of the electronic device 100 to display the first frame by the first display device 102. That is, regardless of what sort of the signal is received, the first frame corresponding to the first function executed by the processor 106 is still displayed on the first display device 102, whereas the second frame corresponding to the signal received is displayed on the second display device 104. As a result, the user can execute operations on the first display device without being interrupted by the signal unexpectedly received by the processor 106.

Altogether, the configuration of dual display devices of the electronic device and the real-time multitask operating method according to the invention allow the user to freely customize specific common functions or select a system default setting as to switch all display contents displayed on the first display device to be displayed on the second display device, so that the user can perform more than two functions at the same time, such as making a phone call while checking on Emails. Moreover, when the signal is received, the electronic device of the invention can also display the frame corresponding to the signal by one display device when the user is still using a specific function on another display device. This allows the user to concentrate in using the electronic device (such as playing game or watching video) without being interrupted by the phone call. Instead, the frame corresponding to the signal received (which is deemed as an interruption to the user) can be displayed on another display device, so that the user can turn the electronic device over and decide whether to answer the phone call.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A real-time multitask operating method for an electronic device, the electronic device having a first display device and a second display device, wherein the first display device and the second display device are respectively disposed on two surfaces of the electronic device corresponding to each other, the method comprises:
receiving a signal when a first function is executed by the electronic device to display a first frame corresponding to the first function on the first display device; and
displaying the first frame and a second frame corresponding to the signal on the first display device and the second display device according to the signal when the first function is still executed by the electronic device, wherein the first frame and the second frame are displayed on different display devices.

2. The real-time multitask operating method of claim 1, wherein the step of displaying the first frame and the second frame corresponding to the signal on the first display device and the second display device, comprising:
displaying the first frame on the second display device when the first function is still executed by the electronic device; and
displaying the second frame on the first display device.

3. The real-time multitask operating method of claim 2, wherein a premise of the steps of displaying the first frame on the second display device and displaying the second frame on the first display device is that the signal matches a display priority of the first display device.

4. The real-time multitask operating method of claim 1, wherein the step of displaying the first frame and the second frame corresponding to the signal on the first display device and the second display device, comprising:
displaying the second frame corresponding to the signal on the second display device according to the signal when the first function is still executed by the electronic device to display the first frame on the first display device.

5. The real-time multitask operating method of claim 1, wherein the second display device comprises an electronic paper display device.

6. The real-time multitask operating method of claim 1, wherein the first display device comprises an electronic paper display device.

7. The real-time multitask operating method of claim 1, wherein the signal comprises a short message, an event notification message, a call signal, a video stream signal or a function-activating signal.

8. An electronic device, comprising:
a first display device;
a second display device, wherein the first display device and the second display device are respectively disposed on two surfaces of the electronic device corresponding to each other;
a processor coupled to the first display device and the second display device, wherein the processor is configured for:
receiving a signal when a first function is executed to display a first frame corresponding to the first function on the first display device; and
displaying the first frame and a second frame corresponding to the signal on the first display device and the second display device according to the signal when the first function is still executed, wherein the first frame and the second frame are displayed on different display devices.

9. The electronic device of claim 8, wherein the processor displaying the first frame and the second frame corresponding to the signal on the first display device and the second display device, further comprises:
displaying the first frame on the second display device when the first function is still executed; and
displaying the second frame on the first display device.

10. The electronic device of claim 9, wherein a premise of displaying the first frame on the second display device and displaying the second frame on the first display device is that the signal matches a display priority of the first display device.

11. The electronic device of claim 8, wherein the processor displaying the first frame and the second frame corresponding to the signal on the first display device and the second display device, further comprises:
displaying the second frame corresponding to the signal on the second display device according to the signal when the first function is still executed to display the first frame on the first display device.

12. The electronic device of claim 8, wherein the second display device comprises an electronic paper display device.

13. The electronic device of claim 8, wherein the second display device comprises an electronic paper display device.

14. The electronic device of claim 8, wherein the signal comprises a short message, an event notification message, a call signal, a video stream signal or a function-activating signal.

15. The electronic device of claim 8, further comprising a detachable case covering a second surface of the electronic device corresponding to a first surface of the electronic device, wherein the second display device is disposed on the detachable case.

16. The electronic device of claim 8, wherein the second display device is configured for receiving a display signal from the processor by using a wired method or a wireless method.
